(19) United States
(12) Patent Application Publication
(10) Pub. No.: US 2009/0089160 A1
(43) Pub. Date: Apr. 2, 2009

(54) Geo-Based Hands-Free Calling Minute Awards

(75) Inventor: Christopher L. Oesterling, Troy, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 11/864,204

(22) Filed: Sep. 28, 2007

(51) Int. Cl. G06Q 99/00; G01S 5/00

(52) U.S. Cl. 705/14

(57) ABSTRACT

A method and system for customer incentives awards calling minutes for wireless telephone service based on the geographic location and the products and services provided to a vehicle. Illustrative examples include, but are not limited to, a user requesting calling minute awards based on a purchased service and a vehicle location at the time of purchase, a telematics service center automatically awarding minutes based on triggers generated by sensors within the telematics unit, and a telematics unit autonomously awarding hands-free minutes based on triggers generated by sensors and vehicle location.

### BACKGROUND OF THE INVENTION

One of the fastest growing areas of communications technology is related to automobile network solutions. Many new American vehicles will have some level of telematics service, and with the increasing number and variety of these services, the opportunities for synergy and cross-marketing between telematics providers and other merchants have grown.

Although it is desirable to cross-market between telematics providers and other merchants such as service stations, it has traditionally been difficult to link appropriate rewards with qualifying purchases. For example, in a more traditional context, a user may send in a rebate form or meet and report a mileage threshold to link purchases and incentives, but in the context of telematics, these traditional solutions break down because of inherent delays and complications to the user.

### BRIEF SUMMARY OF THE INVENTION

The invention provides a method and system to award minutes for wireless telephone service or other incentives based on the geographic location at the time of a purchase and the identity of the products and services provided to a vehicle. Examples of the disclosed principles include, but are not limited to, a user requesting from a telematics service center a hands-free minute award based on vehicle location and a purchased service. Moreover, a telematics service center may automatically award hands-free minutes in keeping with the disclosed principles based on triggers generated by sensors within the telematics unit. Alternatively, the telematics unit may autonomously award hands-free minutes based on triggers generated by sensors and vehicle location.

### BRIEF DESCRIPTION OF THE SEVERAL VIEWS OF THE DRAWINGS

FIG. 1 is a schematic view of an example communication system within which examples of the disclosed principles may be implemented;

FIG. 2 illustrates a general architectural overview of a system contemplated by an exemplary implementation;

FIG. 3 illustrates a general architectural overview of a system contemplated by an exemplary implementation;

FIG. 4 is a flow diagram illustrating an exemplary process of awarding hands-free minutes when requested by a telematics service subscriber;

FIG. 5 is a flow diagram illustrating an exemplary process of awarding hands-free minutes triggered by a telematics unit and verified by a telematics service center;

FIG. 6 is a flow diagram illustrating an exemplary process of awarding hands-free minutes triggered and verified by a telematics unit;

FIG. 7 is a flow diagram illustrating an exemplary process of a service center verifying awards in an HFC minutes awards program; and

FIG. 8 is a flow diagram illustrating an exemplary process of a telematics unit verifying awards in an HFC minutes awards program.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

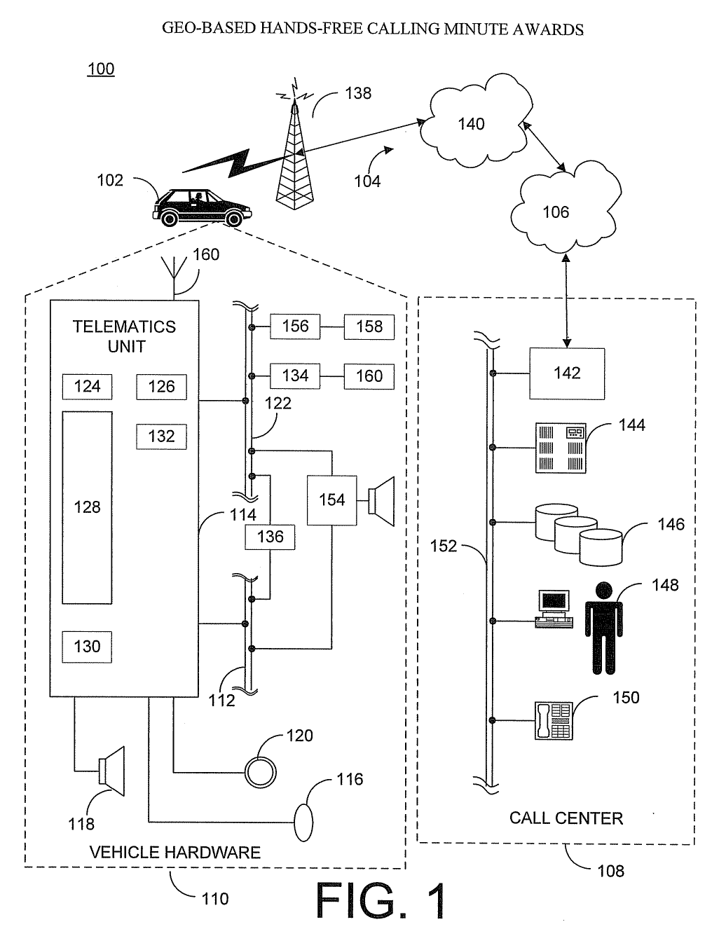

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 160, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

In the context of the foregoing discussion, the following examples will serve to illuminate a unique Geo-Based hands-free calling (HFC) minutes awards program according to the disclosed principles. The telematics unit 114 contains a hands-free wireless phone from which a telematics service subscriber may communicate with other mobile phone users. Further, the telematics unit 114 may provide a telematics service provider with the location of the subscriber's vehicle. In addition, a telematics service provider may access sensor information from the telematics unit. Analyzing sensor information allows a telematics unit 114 or a telematics service center to determine whether certain products and services have been purchased by the subscriber. This technology allows a telematics service provider to offer a HFC minutes awards program for its subscribers. Other awards may be available to subscribers, such as, for example, subscription discounts, additional routes provided by a telematics based turn-by-turn navigation system, concierge services, and the like.

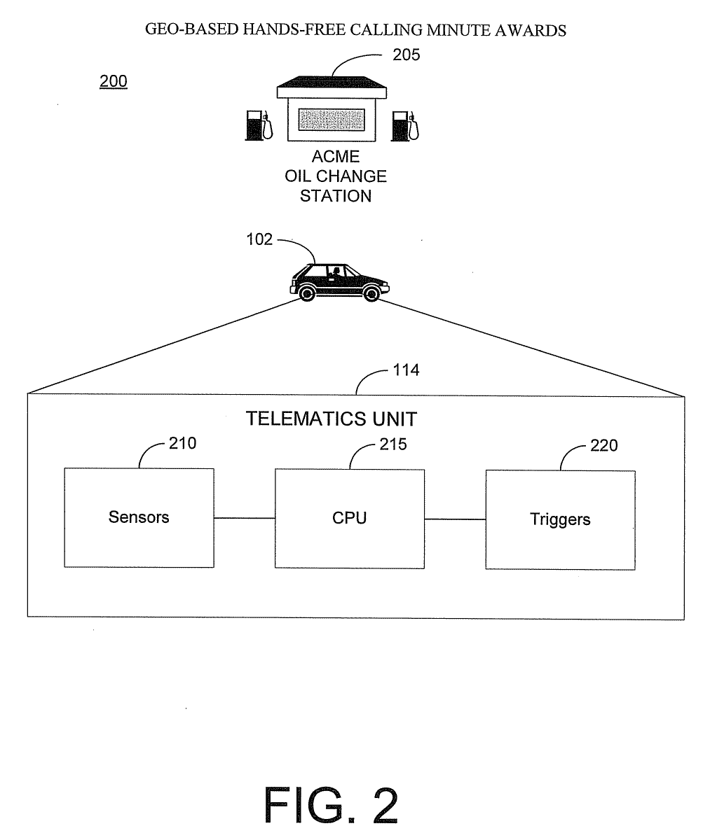

A telematics service provider may choose or solicit businesses to participate in a HFC minutes awards program. Subscribers are awarded HFC minutes when the service provider can verify that a subscriber's vehicle is located at a participating business and that the subscriber has purchased a product or service from the business for the vehicle. For example, FIG. 2 illustrates in general architectural overview 200 a system according to an exemplary implementation. In the illustrated example, ACME Oil Change Station 205 is a participating business in the HFC minutes awards program. Subscriber vehicle 102 may enter the ACME Oil Change Station for oil change service.

The vehicle's telematics unit 114 may contain sensors 210, CPU 215, and triggers 220 that indicate to either the telematics service provider or the telematics unit itself that the vehicle purchased oil change service from ACME Oil Change Station 205. For example, a sensor 210 may indicate that the oil pan has been largely drained and refilled. The CPU 215 may then generate a trigger 220 to notify a service center or telematics unit 114 that a potential service or product was purchased. In addition, a vehicle's telematics unit 114 provides an address or GPS location of the vehicle. Hence, the telematics unit 114 or service provider may determine that the vehicle was indeed at the ACME Oil Change Station 205 at the time of the oil change. Subsequently, after optionally verifying that the ACME Oil Change Station is a participating business in the HFC minutes awards program, the subscriber is awarded an HFC minutes award.

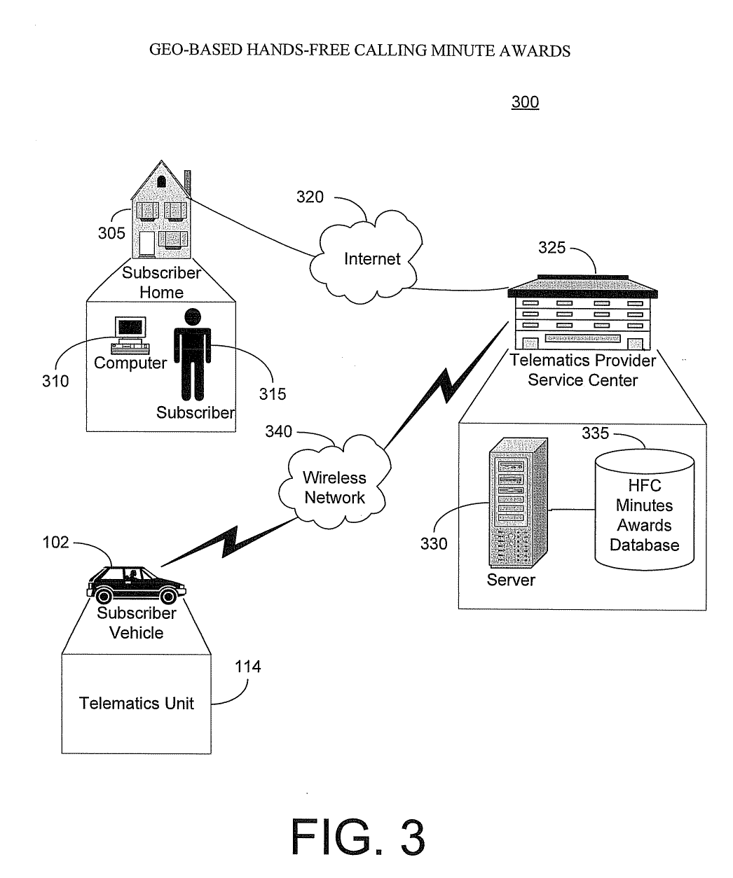

FIG. 3 illustrates a general architectural overview of a system 300 contemplated by an exemplary implementation. The disclosed principles allow a telematics service subscriber 315 to enroll in an HFC minutes awards program offered by a telematics service provider. Enrollment may be completed through a telematics service provider website from a subscriber's home 305 via a computer 310 over the Internet 320. As a subscriber enrolls in an HFC minutes awards program, a telematics provider service center 325 gathers the subscriber information from the online enrollment form and stores the subscriber information into an HFC minutes awards database 335 containing all relevant information for the HFC minutes awards program. This may include, but not limited to, a list of participating businesses, products and services. A server 330 at the service center manages the HFC minutes awards program. A server 330 configures the telematics unit 114 of the subscriber vehicle 102 over a wireless network 340 such that a service center 330 or telematics unit 114 may award HFC minutes when a subscriber purchases products and services from participating businesses.

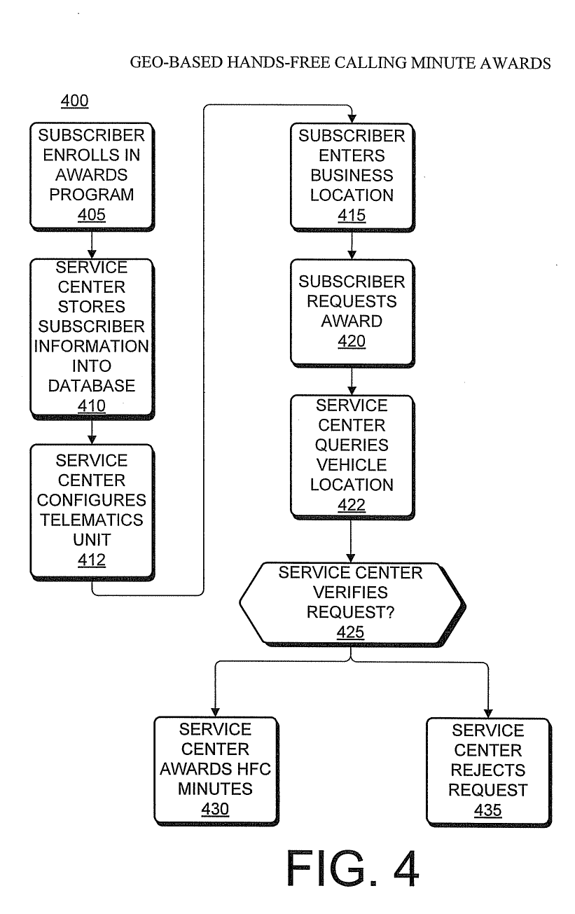

FIG. 4 is a flow diagram 400 illustrating an exemplary process of awarding hands-free minutes when requested by a telematics service subscriber. At stage 405, a telematics service subscriber enrolls in a hands-free minutes awards program. Although FIG. 3 illustrates a subscriber 315 enrolling into an HFC minutes awards program over the Internet 320, this is not required in every case. Other ways to enroll into an HFC minutes awards program may include, but are not limited to, completing and mailing a paper enrollment form through the postal mail service, enrolling over a wired or wireless phone through a customer service representative or automatic voice enrollment program, enrolling through text messaging from a wireless phone, or enrolling from a customer telematics unit.

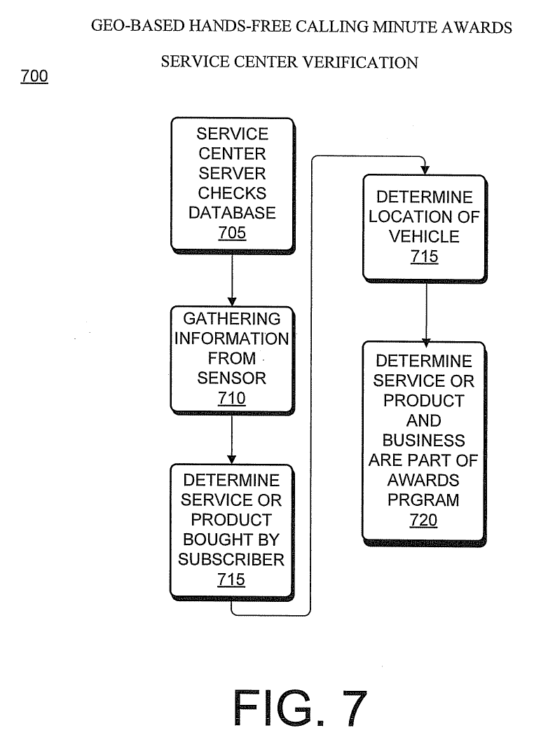

At stage 410, the telematics service provider stores customer information from a paper or electronic enrollment form into a hands-free minutes award system database. At stage 412, a service center server 330 configures a subscriber's telematics unit 114 to indicate to the service center 330 when a sensor is triggered by a purchased service. At stage 415, a subscriber drives a vehicle 102 containing a telematics unit 114 to a participating awards program business location such as an oil change station (See FIG. 3). The subscriber may optionally request an HFC minutes award from the business location through the telematics unit 114 at stage 420. The service center queries the telematics unit 114 at stage 422 for its address and location. At stage 425, the telematics service center verifies that the business participates in the awards program and that the awards service was rendered. Details of the verification process are provided below with reference to FIG. 7. At stage 430, the telematics service center awards the subscriber HFC minutes. Alternatively, at stage 435, the telematics service center rejects the subscriber request because the business or service is not part of the HFC awards program.

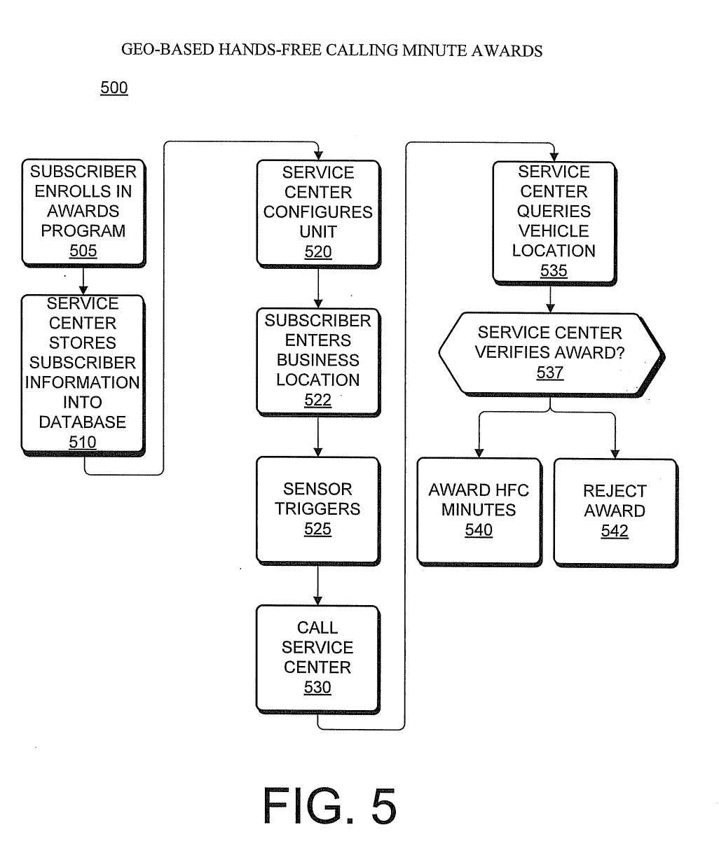

FIG. 5 is a flow diagram illustrating an exemplary process 500 of awarding hands-free minutes triggered by a telematics unit and verified by a telematics service center. At stage 505, the telematics service subscriber enrolls in a hands-free minutes awards program similar to stage 405 in FIG. 4. Subsequently at stage 510, the telematics service provider stores customer information from a paper or electronic enrollment form into a hands-free minutes award system database. At stage 520, the service center server 330 configures a subscriber's telematics unit 114 to indicate to the service center when a sensor is triggered by a purchased service. The subscriber drives a vehicle 102 containing a telematics unit 114 to a participating awards program business location such as an oil change station (See FIG. 3) at stage 522, and a service or product such as an oil change (See FIG. 3) is purchased from the business. At stage 525, a vehicle sensor generates a trigger indicating that a service has been rendered that is potentially from the HFC minutes awards program. At stage 530, the telematics unit 114 calls the service center with the sensor information from the trigger. Subsequently at stage 535, the service center queries the telematics unit 114 for its address and location. At stage 537 the service center verifies the HFC minutes award, as discussed in greater detail hereinafter with reference to FIG. 7. If the service center verifies the award 540, then it awards the subscriber HFC minutes. Otherwise, at stage 542, the service center rejects the award.

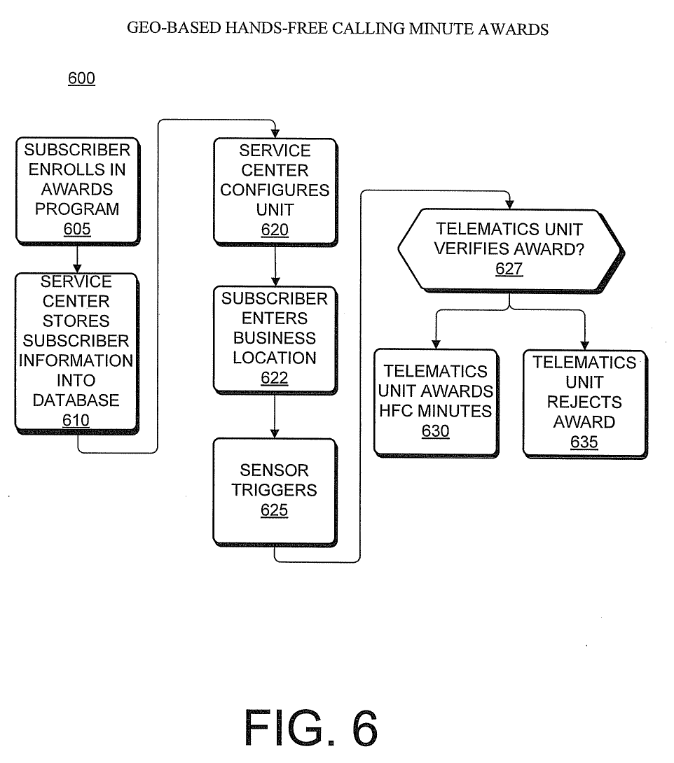

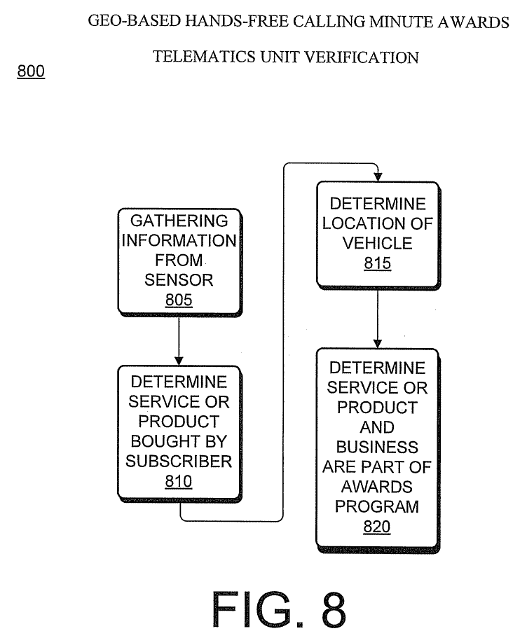

FIG. 6 is a flow diagram 600 illustrating an exemplary process of awarding hands-free minutes triggered and verified by a telematics unit. At stage 605, the telematics service subscriber enrolls in a hands-free minutes awards program similar to stage 405 in FIG. 4. The telematics service provider stores customer information from a paper or electronic enrollment form into a hands-free minutes award system database at stage 610. At stage 620, the service center server 330 configures the subscriber's telematics unit 114 to indicate to the telematics unit when a sensor is triggered by a purchased service. In addition, the server 330 configures the telematics unit to verify the address and location of the subscriber vehicle when a sensor is triggered by providing it with a list of participating business in the HFC minutes awards program. At stage 622, a subscriber drives the vehicle 102 containing a telematics unit 114 to a participating awards program business location such as an oil change station (See FIG. 3). A service or product such as an oil change (See FIG. 3) is then purchased from the business. At stage 625, a vehicle sensor generates a trigger indicating that a service has been rendered that is potentially associated with the HFC minutes awards program. At stage 627, the telematics unit 114 verifies the award. Details of the verification process are described hereinafter with reference to FIG. 8. If the telematics unit 114 verifies the award 630, then it awards the subscriber HFC minutes. Otherwise, at stage 635, the telematics unit rejects the award.

FIG. 7 is a flow diagram illustrating an exemplary process 700 of a service center verifying awards in an HFC minutes awards program. The method shown in FIG. 7 corresponds to, but does not limit, stages 425 and 537 of FIGS. 4-5 respectively. At stage 705, the service center checks the awards system database to determine whether the customer is enrolled in the awards program. The service center gathers information from a vehicle sensor such as an oil level sensor by communicating with a telematics unit 114 at stage 710. At stage 715, the service center identifies a product or service purchased by the subscriber by analyzing the sensor information. At stage 715, using the address and GPS location information given by the telematics unit 114, the service center identifies the business offering the service or product, e.g., ACME Oil Change Station (See FIG. 3). At stage 720, the service center determines whether the business and service participate in the hands-free calling minutes awards program by checking the awards program database.

FIG. 8 is a flow diagram illustrating an exemplary process 800 of a telematics unit verifying awards in an HFC minutes awards program. The method shown in FIG. 8 corresponds to, but does not limit, stage 627 in FIG. 6. At stage 805 a telematics unit 114 gathers information from a sensor such as the vehicle oil level sensor. At stage 810, the telematics unit 114 determines whether a product or service such as an oil change has been purchased by the subscriber by analyzing sensor information. At stage 815, the telematics unit 114 determines the location of the vehicle based on its address and GPS location such as the ACME Oil Change Station (See FIG. 3). At stage 820, the telematics unit 114 determines whether the business and product or service participate in the hands-free calling minutes awards program based on the information given to it by the service center during configuration.

It will be appreciated that a new and useful system for facilitating a hands-free calling award program has been described. In light of the disclosed principles, variations of illustrated examples may become apparent to those of ordinary skill in the art. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method for awarding calling minutes based on a telematics subscriber purchasing products or services from participating businesses using vehicle sensor information and telematics location information, the method comprising:
enrolling a subscriber in a calling minutes awards program;
storing subscriber information in a calling minutes awards program database;
configuring a subscriber telematics unit to detect when a potential product or service associated with the awards program is purchased by the subscriber;
detecting a purchase by the subscriber at a business location in a vehicle associated with the telematics unit;
verifying a calling minutes award request; and
determining whether to honor or reject the request based on the purchase and the identity of the business.

2. The method according to claim 1, further comprising checking the minutes awards database to determine whether the subscriber is enrolled in the minutes awards program.

3. The method according to claim 1, wherein detecting a purchase by the subscriber at a business location in a vehicle associated with the telematics unit comprises:
gathering information from telematics unit sensors associated with the vehicle;
analyzing sensor information to determine a product or service purchased by the subscriber; and
determining the business location of the vehicle using the telematics unit's GPS system.

4. The method according to claim 1, wherein determining whether to honor or reject the request based on the purchase and the identity of the business comprises determining whether the product or service and the business participate in an minutes awards program.

5. The method according to claim 1, wherein verifying a calling minutes award request comprises:
receiving a subscriber request for a calling minute award from the telematics unit;
querying the telematics unit for sensor information and vehicle location; and
verifying the subscriber request for a calling minute award.

6. The method according to claim 1, the method further comprising the steps of:
a sensor generating a trigger prompting a verification of whether to award calling minutes;
a telematics unit calling a service center when trigger is generated notifying the service center to verify whether to award a subscriber calling minutes;
querying the telematics unit by a service center for sensor information and vehicle location; and
verifying the subscriber request at the service center.

7. The method according to claim 1, the method further comprising the steps of:
generating a trigger based on data from a vehicle sensor to prompt a verification of whether to award a subscriber calling minutes; and
a telematics unit verifying a calling minutes award.

8. The method according to claim 1, wherein a enrolling a subscriber into an HFC minutes awards program comprises enrolling the subscriber via a system selected from the group consisting of a computer, a paper enrollment form, a phone communication, a messaging device, and a telematics unit.

9. The method according to claim 1, wherein the communication network is selected from the group consisting of a packet data network, a circuit switched network, a wireless network, a cellular network, a WiFi network, a WiMAX network, an Internet, a local area network, a wide area network, and a metropolitan access network.

10. A method for rewarding customers pursuant to an award program for the purchase of products or services from a participating business using vehicle sensor information and telematics location information provided by a vehicle telematics unit, the method comprising:
detecting via a telematics unit a purchase by a telematics subscriber at a business location in a vehicle associated with the telematics unit;
receiving an award request; and
determining whether to honor or reject the request based on the product or service purchased and the identity of the business.

11. The method according to claim 10, further comprising querying an award database to determine whether the subscriber is enrolled in the award program

12. The method according to claim 10, wherein detecting via the telematics unit a purchase by the telematics subscriber comprises:
gathering sensor information from the telematics unit based on data from one or more sensors associated with the vehicle;
analyzing the sensor information to identify the product or service purchased by the subscriber; and
determining that the vehicle is at the business location using a GPS system associated with the telematics unit.

13. The method according to claim 10, wherein determining whether to honor or reject the request based on the purchase and the identity of the business comprises determining whether the product or service and the business participate in the award program.

14. The method according to claim 10, wherein determining whether to honor or reject the request based on the product or service purchased and the identity of the business comprises querying the telematics unit for sensor information to identify the product or service and vehicle location information to identify the business location.

15. The method according to claim 10, further comprising:
a sensor generating a trigger prompting a verification of whether to award calling minutes;
a telematics unit calling a service center when trigger is generated notifying the service center to verify whether to award a subscriber calling minutes;
querying the telematics unit by a service center for sensor information and vehicle location; and
verifying the subscriber request at the service center.

16. The method according to claim 10, wherein transmission of the reward request is triggered by data from a vehicle sensor.

17. The method according to claim 10, further comprising enrolling a subscriber into the award program via a system selected from the group consisting of a computer, a paper enrollment form, a phone communication, a messaging device, and a telematics unit.

18. The method according to claim 10, wherein the vehicle telematics unit communicates wirelessly via a communication network selected from the group consisting of a packet data network, a circuit switched network, a wireless network, a cellular network, a WiFi network, a WiMAX network, an Internet, a local area network, a wide area network, and a metropolitan access network.

19. A computer-readable medium having thereon computer-executable instructions for facilitating a method of rewarding a telematics subscriber pursuant to an award program for the purchase of products or services from a participating business using vehicle sensor information and telematics location information provided by a vehicle telematics unit, the computer-readable medium comprising:
instructions for automatically notifying a call center of a purchase by the telematics subscriber at a business location in a vehicle associated with the telematics unit;
instructions for requesting an award based on the purchase; and
instructions for receiving a notification of the status of the request.

20. The method according to claim 19, wherein the instructions for automatically notifying a call center of a purchase by the telematics subscriber at a business location in a vehicle associated with the telematics unit comprise:
instructions for gathering sensor information from one or more sensors associated with the vehicle to identify the purchase; and
instructions for determining the vehicle location.
